(19) United States
(12) Patent Application Publication
(10) Pub. No.: US 2026/0241758 A1
(43) Pub. Date: Aug. 20, 2026

(54) HITCH PIN ASSEMBLY

(71) Applicant: B & W Custom Truck Beds, Inc., Humboldt, KS (US)

(72) Inventor: Travis M. McCall, Humboldt, KS (US)

(73) Assignee: B & W Custom Truck Beds, Inc., Humboldt, KS (US)

(21) Appl. No.: 19/542,337

(22) Filed: Feb. 17, 2026

Related U.S. Application Data
(60) Provisional application No. 63/759,424, filed on Feb. 17, 2025.

(51) Int. Cl. B60D 1/60; B60D 1/28

(52) U.S. Cl. CPC B60D 1/60; B60D 1/28

(57) ABSTRACT

A hitch pin assembly for preventing theft of a trailer hitch includes a hitch pin, a housing block, and a pin receptacle received within the housing block. The pin receptacle forms a ball channel in which a ball bearing is situated, the ball bearing selectively receivable by a first groove formed in the hitch pin and a second groove formed in the housing block. Advancement of the hitch pin into and out of the pin receptacle urges the ball bearing to traverse through the ball channel between the first and second grooves. The hitch pin assembly may include a biasing element to bias the pin receptacle toward a set position, and a lock including a bolt selectively engageable with the pin receptacle.

### CROSS REFERENCE TO RELATED APPLICATION

This application claims the benefit of U.S. Provisional Patent Application No. 63/759,424 filed February 17, 2025, the disclosure of which is hereby incorporated herein in its entirety by reference.

### FIELD OF THE INVENTION

This invention relates to hitch pins for trailer hitches and components thereof, and in particular to a hitch pin in combination with a lockable hitch pin receiver.

### BACKGROUND

Trailer hitch pins are commonly used to secure a hitch-mounted accessory, such as a ball mount or cargo carrier, to a vehicle’s hitch receiver. Conventional hitch pins typically include a cylindrical pin that extends through aligned apertures in the hitch receiver and accessory shank, with a securing mechanism, such as a clip or cotter pin, to prevent unintentional disengagement.

While standard hitch pins effectively retain towing components in position, they do not provide security against unauthorized removal. To address this concern, locking hitch pins have been developed, incorporating lockable mechanisms that resist unauthorized access and tampering. These devices generally employ keyed or combination locks to secure the pin in place, preventing removal without the proper unlocking mechanism.

Existing locking trailer hitch pins vary in their locking configurations, structural designs, and materials. Some utilize cylindrical or tubular locks, while others incorporate deadbolt-style locking mechanisms. However, conventional locking hitch pins may be susceptible to failure due to environmental exposure, corrosion, or forced entry attempts, such as cutting, picking, or impact forces. Furthermore, many designs are cumbersome to operate and are prone to ingress of moisture, dirt, and other debris which may obstruct the functionality of locking components.

### SUMMARY

Embodiments of the invention are defined by the claims below, not this summary. A high-level overview of various aspects of the invention is provided here to introduce a selection of concepts that are further described in the Detailed Description section below. This summary is not intended to be used in isolation to determine the scope of the claimed subject matter. In brief, this disclosure describes, among other things, a hitch pin assembly for preventing theft of trailer hitches.

The hitch pin assembly includes a hitch pin, a housing block, and a pin receptacle received within the housing block and configured to receive the hitch pin. The pin receptacle forms a ball channel in which a ball bearing is situated, with the ball bearing receivable by a first groove formed in the hitch pin and a second groove formed in the housing block. Advancement of the hitch pin into the pin receptacle urges the ball bearing to traverse through the ball channel between the first and second grooves. The hitch pin, pin receptacle, and housing cooperate to urge the ball bearing outward into the second groove and draw the ball bearing inward into the first groove as the hitch pin is advanced into and withdrawn from the pin receptacle. The pin receptacle is biased toward a set position by a biasing member extending between the housing block and a base of the pin receptacle. A lock is received within the housing block and includes a bolt selectively advanceable to engage the base of the pin receptacle when the pin receptacle is in the set position, thereby fixing the position of the pin receptacle relative to the housing block.

The first groove is spaced from a distal end of the hitch pin and the second groove is spaced from an end wall of the housing block such that, when respective abutment surfaces are engaged, each groove is aligned with a transverse plane intersecting the ball channel. Cam edges formed on the hitch pin urge the ball bearing outward through the ball channel during insertion and removal of the hitch pin, and the ball bearing engages a retaining lip formed on the pin receptacle when the ball bearing traverses inward through the ball channel.

### DESCRIPTION OF THE DRAWINGS

Illustrative embodiments of the invention are described in detail below with reference to the attached drawing figures, and wherein:

FIG. 1 is a perspective view of a hitch pin assembly in accordance with an embodiment of the invention, viewed from above and to the right, and depicted with the hitch pin assembly lockably securing a trailer hitch assembly to a hitch receiver;

FIG. 2 is a rear elevational view of the hitch pin assembly of FIG. 1, depicted with the hitch pin assembly lockably securing the trailer hitch assembly to the hitch receiver;

FIG. 3 is a perspective view of the hitch pin assembly of FIG. 1, viewed from below and to the right, and depicted with a hitch pin lockably secured to a locking receiver;

FIG. 4 is a perspective view of the hitch pin of the hitch pin assembly of FIG. 1, viewed from above and to the left;

FIG. 5 is a perspective view of the locking receiver of the hitch pin assembly of FIG. 1, viewed from below and to the right;

FIG. 6 is a section view of the locking receiver of the hitch pin assembly of FIG. 1, taken in a central longitudinal plane of the locking receiver and viewed from the rear;

FIG. 7 is a rear elevational view of a pin receptacle of the locking receiver of the hitch pin assembly of FIG. 1;

FIG. 8 is a bottom plan view of a housing block of the locking receiver of the hitch pin assembly of FIG. 1;

FIG. 9 is a top plan view of a lock of the locking receiver of the hitch pin assembly of FIG. 1;

FIG. 10 is a section view of the hitch pin assembly of FIG. 1, taken in a central plane of the hitch pin assembly and viewed from the rear, and depicted with the pin receptacle of the locking receiver in a set position and with the hitch pin separated from the locking receiver;

FIG. 11 is a right elevational view of the hitch pin assembly of FIG. 1, depicted with the hitch pin lockably secured to the locking receiver;

FIG. 12 is a section view of the hitch pin assembly of FIG. 1, taken generally along line 12 in FIG. 11, and depicted with the pin receptacle of the locking receiver in a set position and with the hitch pin advanced partially into the pin receptacle;

FIG. 13 is a section view of the hitch pin assembly of FIG. 1, taken generally along line 13 in FIG. 11, and depicted with the pin receptacle of the locking receiver pressed out of a set position and with the hitch pin advanced partially into the pin receptacle;

FIG. 14 is a section view of the hitch pin assembly of FIG. 1, taken generally along line 14 in FIG. 11, and depicted with the pin receptacle of the locking receiver pressed out of a set position and with the hitch pin advanced fully into the pin receptacle;

FIG. 15 is a section view of the hitch pin assembly of FIG. 1, taken generally along line 15 in FIG. 11, and depicted with the pin receptacle of the locking receiver in a set position and with the hitch pin advanced fully into the pin receptacle;

FIG. 16 is a section view of the hitch pin assembly of FIG. 1, taken generally along line 16 in FIG. 11, and depicted with the pin receptacle of the locking receiver in a set position, the hitch pin advanced fully into the pin receptacle, and a lock advanced to a locked position.

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Directional references may be used herein for convenience in reference only and should not be interpreted in a limiting sense. For example, the words the words “inward” and “outward” will refer to directions toward and away from, respectively, the geometric center of the embodiment being described and designated parts thereof. The words “mounted,” “connected,” “joined,” “attached,” “secured,” or variations thereof will refer to parts, elements, or components that are both formed separately or joined together, as by welding or through a mechanical coupling, or parts, elements, or components that are integrally formed together. The terms “about” or “approximately” as used herein denote deviations from the exact value by +/- 10%, preferably by +/- 5%, and/or deviations in the form of changes that are insignificant to the described function. Said terminology will include the words specifically mentioned, derivatives thereof, and words of a similar import.

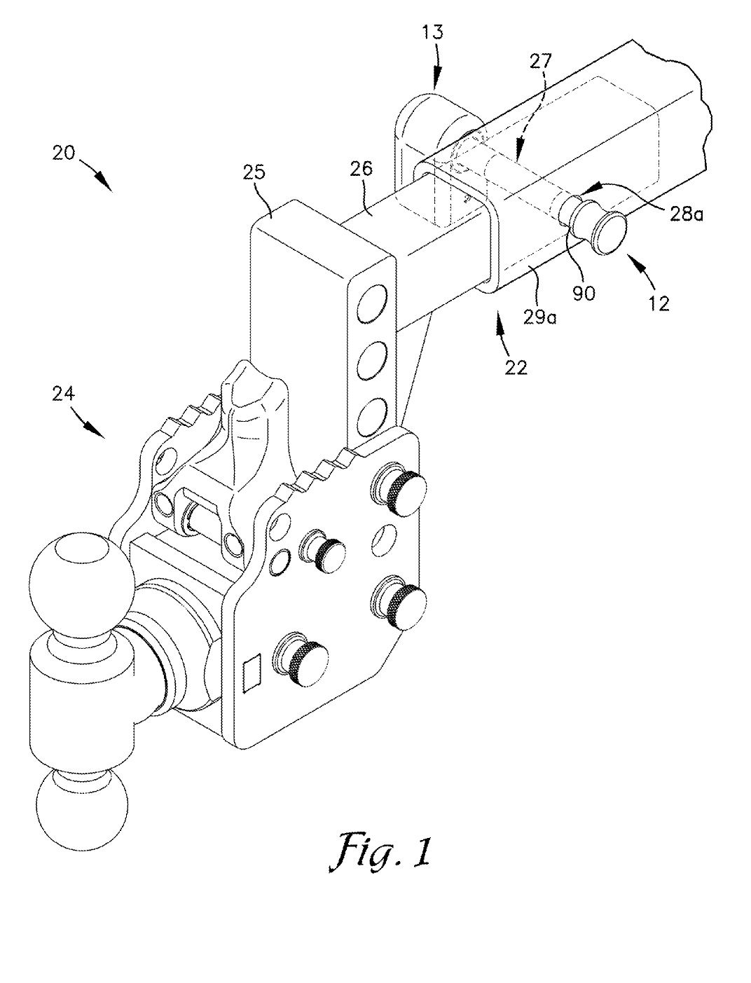

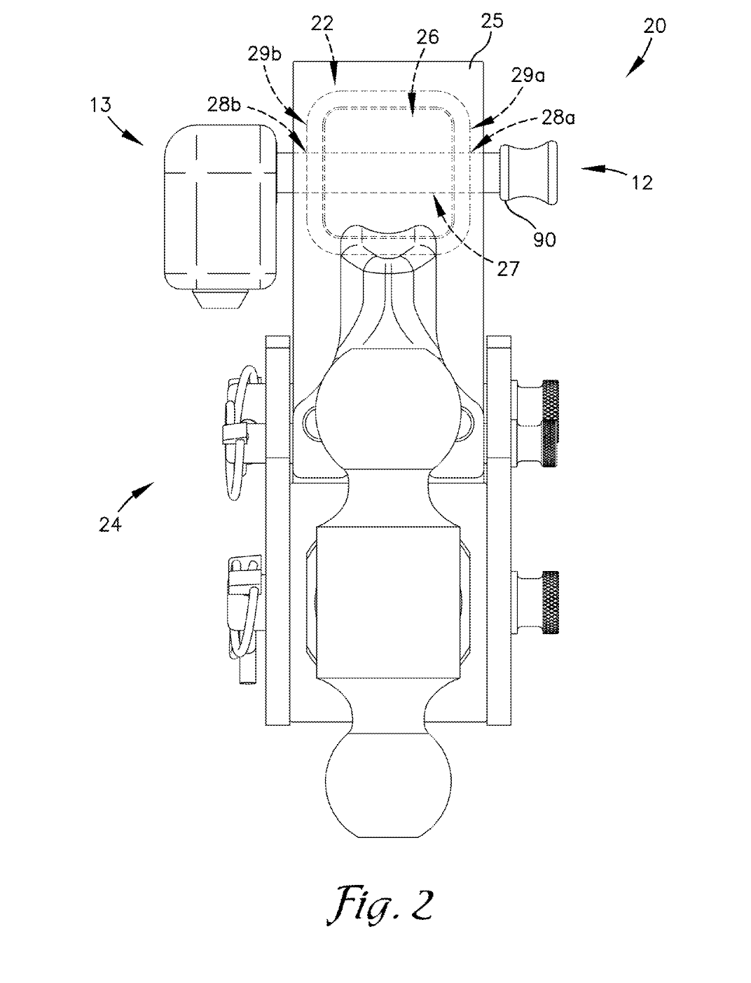

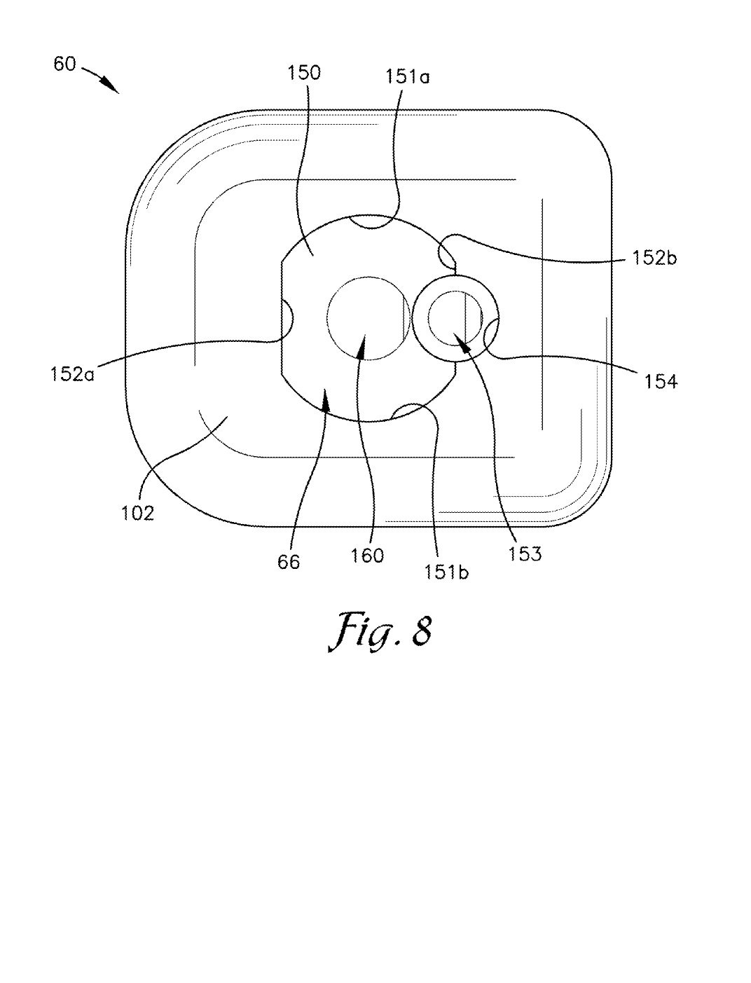

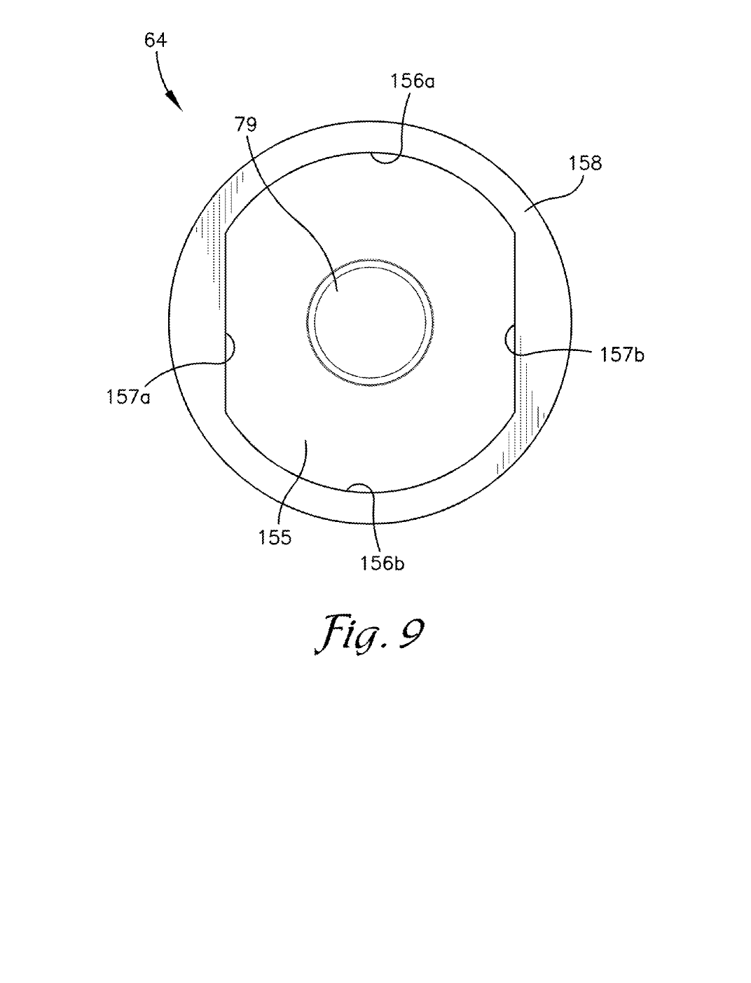

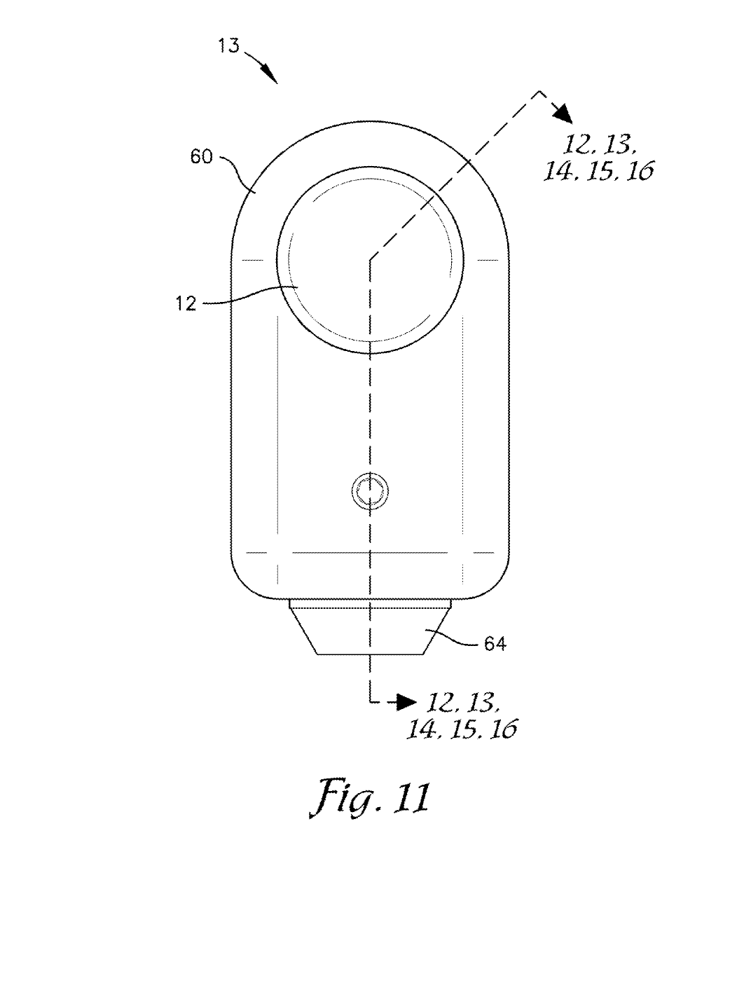

Referring to the drawings in more detail, FIGS. 1-16 show a hitch pin assembly 11 including a hitch pin 12 which is lockably securable within a hitch pin receiver 13. The hitch pin assembly 11, which may be referred to as the locking hitch pin assembly 11, prevents theft of a hitch assembly 20 used to connect a trailer (not shown) to a towing vehicle (not shown). By way of non-limiting example, the locking hitch pin assembly 11 is shown and described herein as lockably and removably securing a stowable pintle-type hitch assembly 20 to a hitch receiver tube 22 mounted to a towing vehicle. The hitch assembly 20 includes a pintle hitch 24 which is adjustably secured to a drawbar 25, with a shank 26 extending away from the drawbar 25 and sized to fit snugly within the hitch receiver tube 22. A pin receiving opening 27 extends laterally through the shank 26 in an axis extending transverse to a central longitudinal axis of the shank 26. When the shank 26 is received within the hitch receiver tube 22, as shown in FIGS. 1 and 2, the pin receiving opening 27 extends coaxial with a pair of axially aligned pin receiving openings 28a and 28b which are formed in respective sidewalls 29a and 29b of the hitch receiver tube 22. As will be described in greater detail herein, advancement of the hitch pin 12 through the pin receiving openings 27, 28a, 28b and into the locking receiver 13 allows the locking hitch pin assembly 11 to lockably secure the hitch assembly 20 to the vehicle-mounted hitch receiver tube 22. Although the locking hitch pin assembly 11 is shown and described herein with reference to the pintle-type hitch assembly 20, it should be understood that the locking hitch pin assembly 11 is well-adapted to prevent theft of a wide variety of hitch assemblies for connecting trailers to towing vehicles, including stowable ball-type hitch assemblies, hitch assemblies having stacked receivers, and virtually any other type of trailer hitch equipped with a shank receivable within a vehicle-mounted receiver tube.

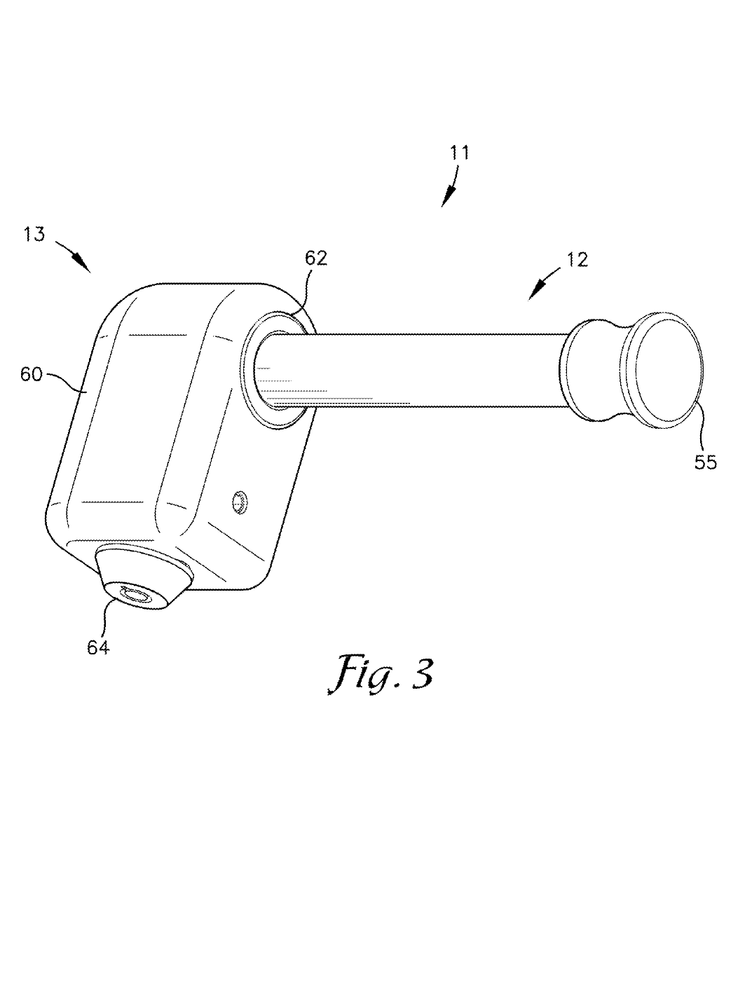

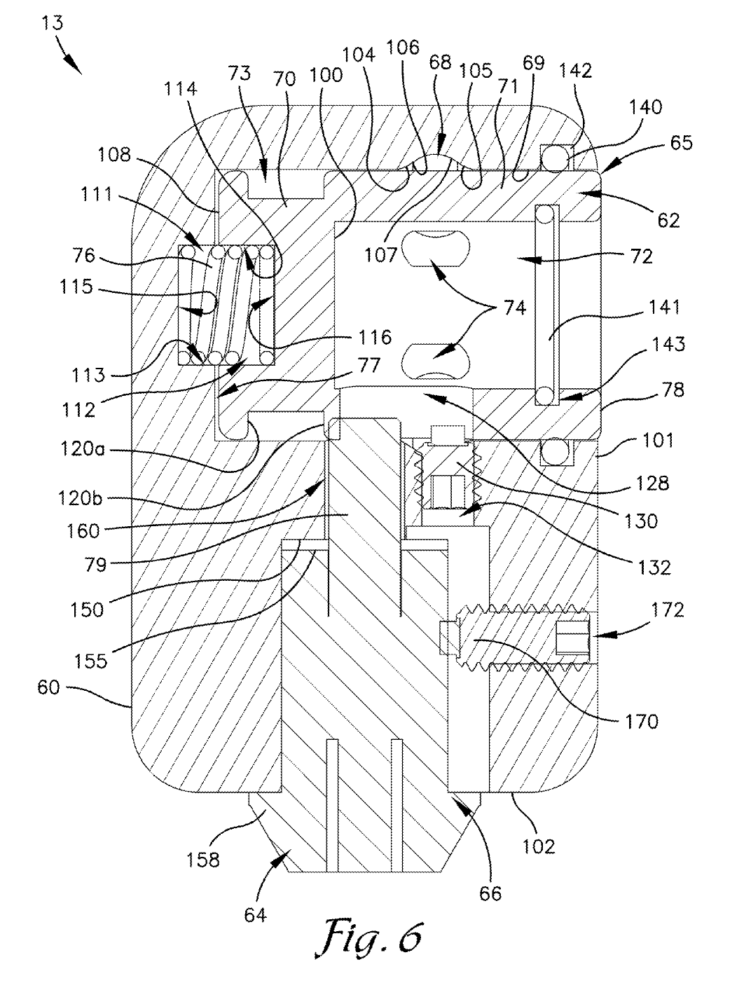

Referring to FIGS. 3-5, the hitch pin 12 extends longitudinally from a head end 55 to a distal end 56, with a first or inner detent receiving feature 58, which may be referred to as a detent or ball receiving groove 58, formed in the hitch pin 12 proximate the distal end 56. The hitch pin receiver 13 includes a housing block 60, a pin receptacle 62, and a lock or lock barrel 64. Referring to FIG. 6, a first or receptacle receiving chamber 65 and a second or lock receiving chamber 66 extend inward into the housing block 60 in generally transverse relation to each other, with a second or outer detent receiving feature 68, which may be referred to as a detent or ball receiving groove 68, extending outward into the housing block 60 from a sidewall 69 of the receptacle receiving chamber 65.

The pin receptacle 62 is slidably retained in the receptacle receiving chamber 65 and includes a base 70 and a sidewall 71 that cooperate to define a pin receiving bore or pin receiving cavity 72 in which the distal end 56 and the first detent receiving groove 58 of the hitch pin 12 extend when the hitch pin 12 is received by the locking receiver 13. The pin receptacle base 70 includes a bolt receiving feature or groove 73, and the pin receptacle sidewall 71 includes a plurality of detent or ball channels 74 extending therethrough, with detents 75 advanceable through the ball channels 74. The detents 75 are sized to be selectively and alternatively advanced into and received by the first and second detent receiving grooves 58 and 68, with the detents 75 having a thickness greater than the thickness of the pin receptacle sidewall 71 such that, as the hitch pin 12 is advanced into the pin receptacle 62, each detent 75 is extendable within a respective ball channel 74 and inner detent receiving feature 58, and within a respective ball channel 74 and outer detent receiving feature 68. In the embodiment shown and described herein, the detents 75 are ball bearings 75; however, it is entirely within the ambit of exemplary embodiments to provide other detent configurations, including arms, pins, plungers, and the like. It will be appreciated that the thickness of a detent 75 may comprise a diameter, as in the embodiment shown, and may further comprise a length corresponding to the distance the detent 75 extends within the detent channel 74 and first and second detent receiving features 58 and 68.

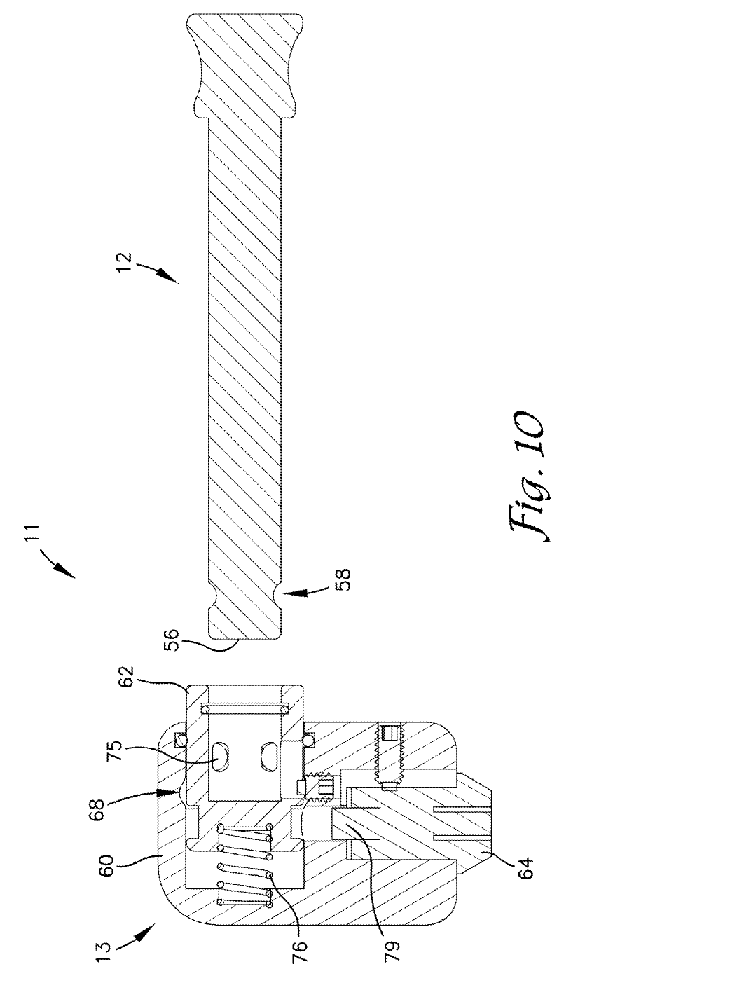

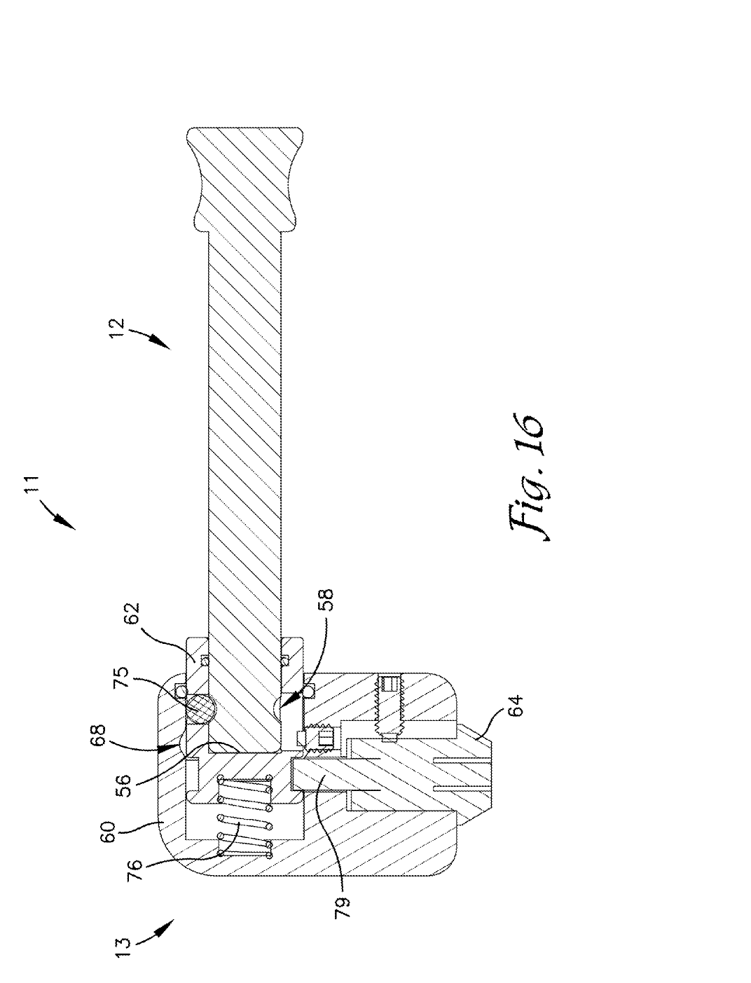

A biasing member, which in the embodiment shown comprises a spring 76, extends between the receptacle receiving chamber 65 and the pin receptacle base 70, with the biasing member 76 extending proximate an end wall 77 of the receptacle receiving chamber 65 and normally biasing the pin receptacle 62 to a set position wherein the ball bearings 75 are spaced apart from the second ball receiving groove 68 (see FIGS. 10, 12, 15 and 16). In the embodiment shown, a rim 78 of the pin receptacle sidewall 71 extends out of the housing block 60 when the pin receptacle 62 is biased to the set position. The lock 64 is fixedly retained in the lock receiving chamber 66 and includes an extendable and retractable bolt 79, with the lock 64 advanceable between a first or unlocked position wherein the bolt 79 is retracted into the lock 64 and a second or locked position wherein the bolt 79 extends out of the lock 64. As shown in FIG. 16, when the pin receptacle 62 is biased to the set position, advancement of the lock 64 to the locked position extends the bolt 79 into the bolt groove 73 to lock the pin receptacle 62 in the set position.

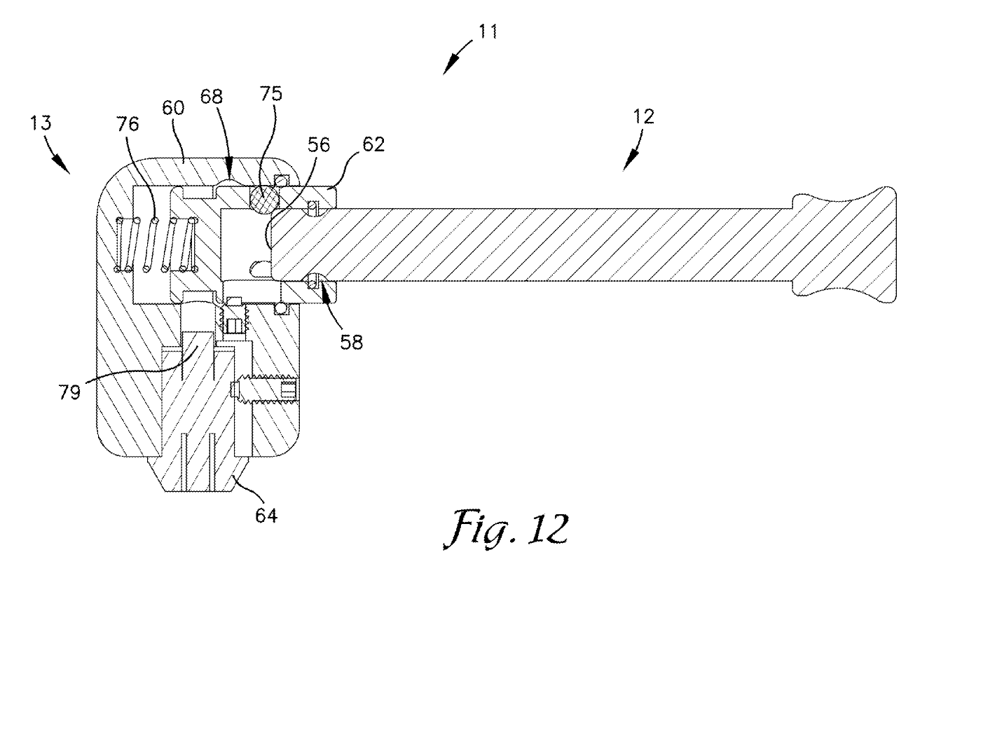

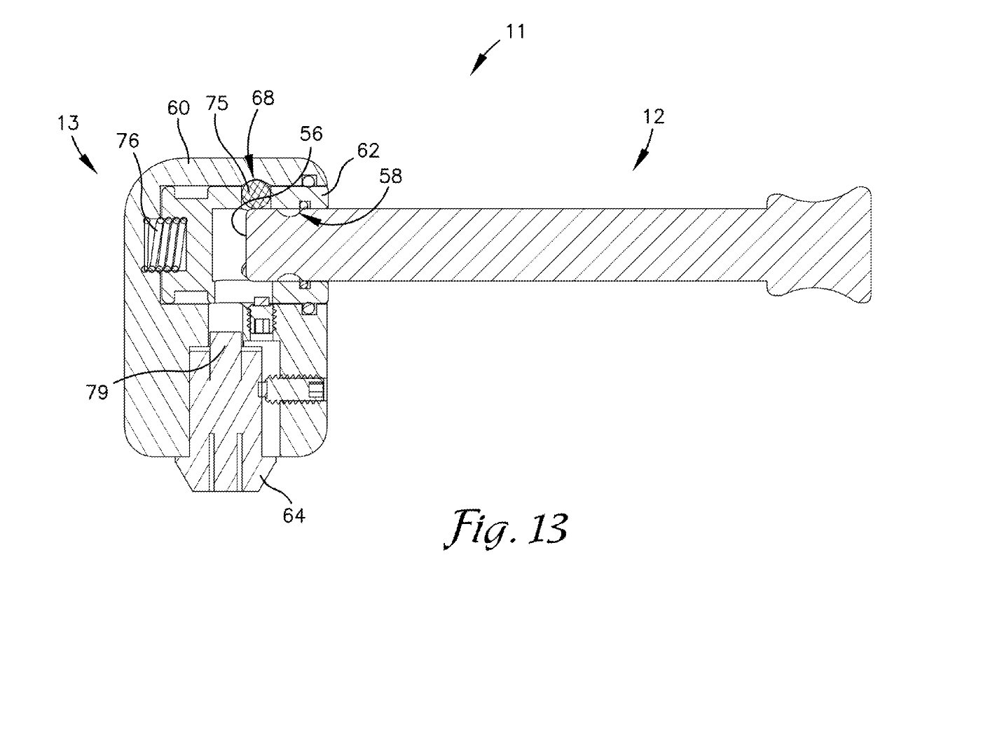

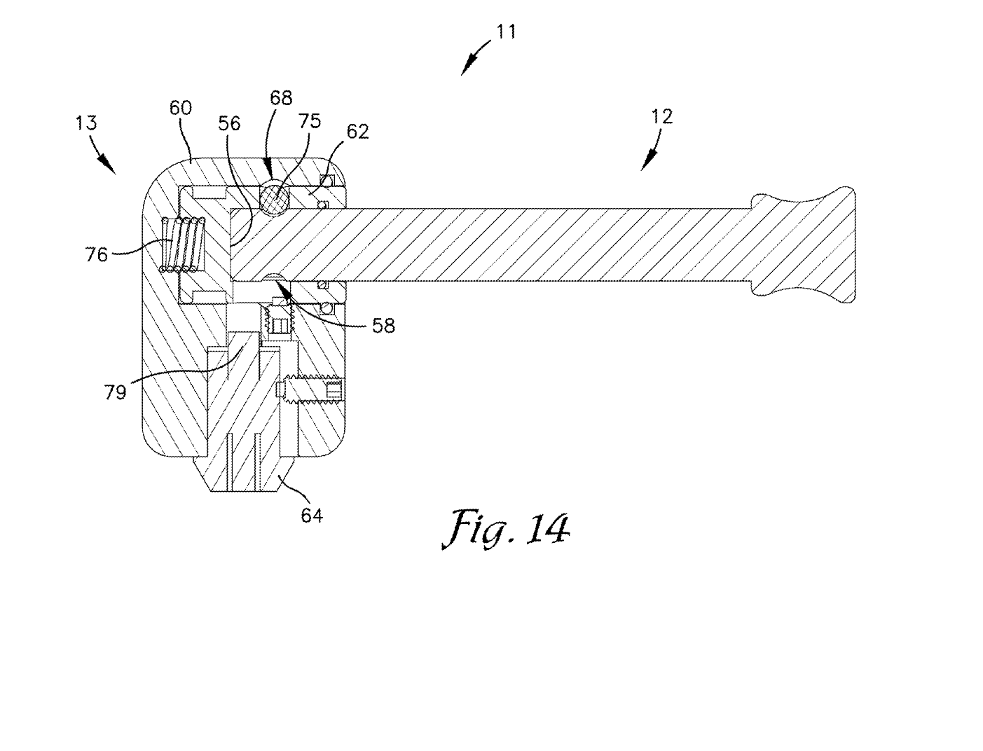

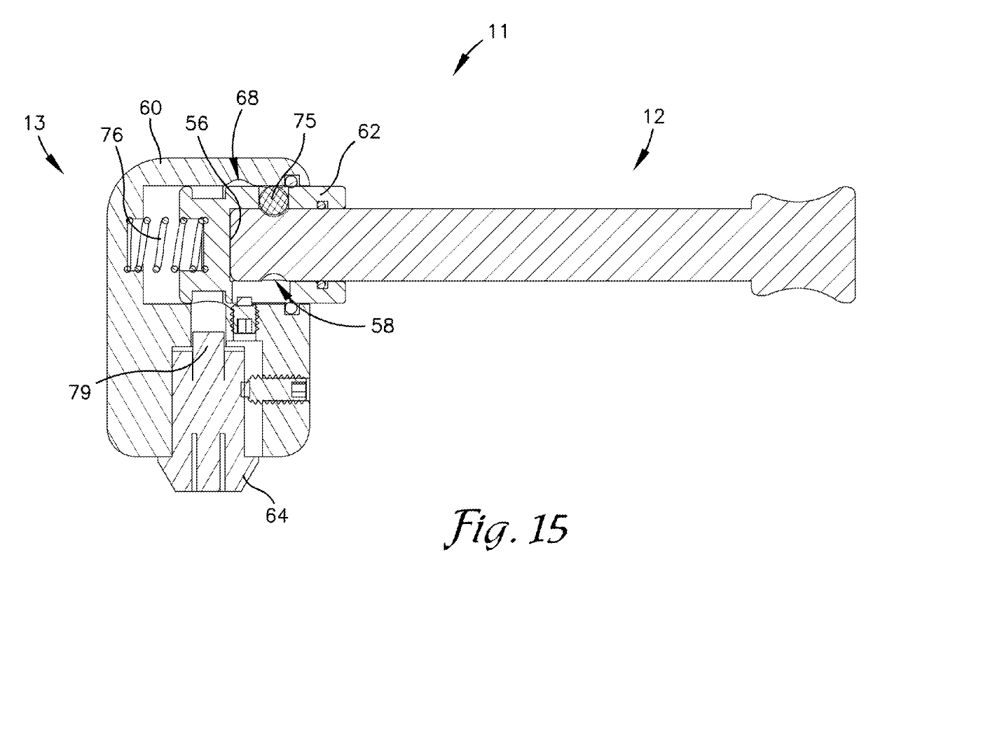

To lock the hitch pin 12 to the locking receiver 13, the hitch pin 12 is advanced into the pin cavity 72 until its distal end 56 engages the ball bearings 75 (see FIG. 12), which are prevented from advancing radially outward by the receptacle sidewall 69. As the hitch pin 12 is pressed further inward, the pin receptacle 62 advances inward against the bias of the biasing member 76 and out of the set position such that the pin receptacle 62 slides toward the end wall 77 of the receptacle receiving chamber 65. When the base 70 of the pin receptacle 62 abuts against the end wall 77 of the receptacle receiving chamber 65 (see FIG. 13), the distal end 56 of the hitch pin 12 forces the ball bearings 75 radially outward and through the ball channels 74, until portions of the ball bearings 75 are received by the second detent receiving groove 68. With the ball bearings 75 disengaged from its distal end 56, the hitch pin 12 is advanced further into the pin cavity 72 until the first detent receiving groove 58 of the hitch pin 12 advances into alignment with the ball channels 74 of the pin receptacle 62 and the second detent receiving groove 68 of the housing block 60 such that the ball bearings 75 are allowed to advance out of the second detent receiving groove 68 and inward, through the ball channels 74, until portions of the ball bearings 75 are received by the first detent groove 58 (see FIG. 14). From this position, when the force advancing the hitch pin 12 into the pin receptacle 62 is released, the biasing member 76 biases the pin receptacle 62 back toward the set position (see FIG. 15). As the pin receptacle 62 advances back to the set position, a radially outer portion of each detent ball 75 in the second detent receiving groove 68 is forced radially inward through the respective ball channel 74, out of the second ball receiving groove with a radially inner portion of each detent ball advancing into the first detent receiving groove 58. With the pin receptacle 62 back in the set position, the lock 64 may be advanced from the unlocked position to the locked position such that the bolt 79 extends into the bolt groove 73 (see FIG. 16).

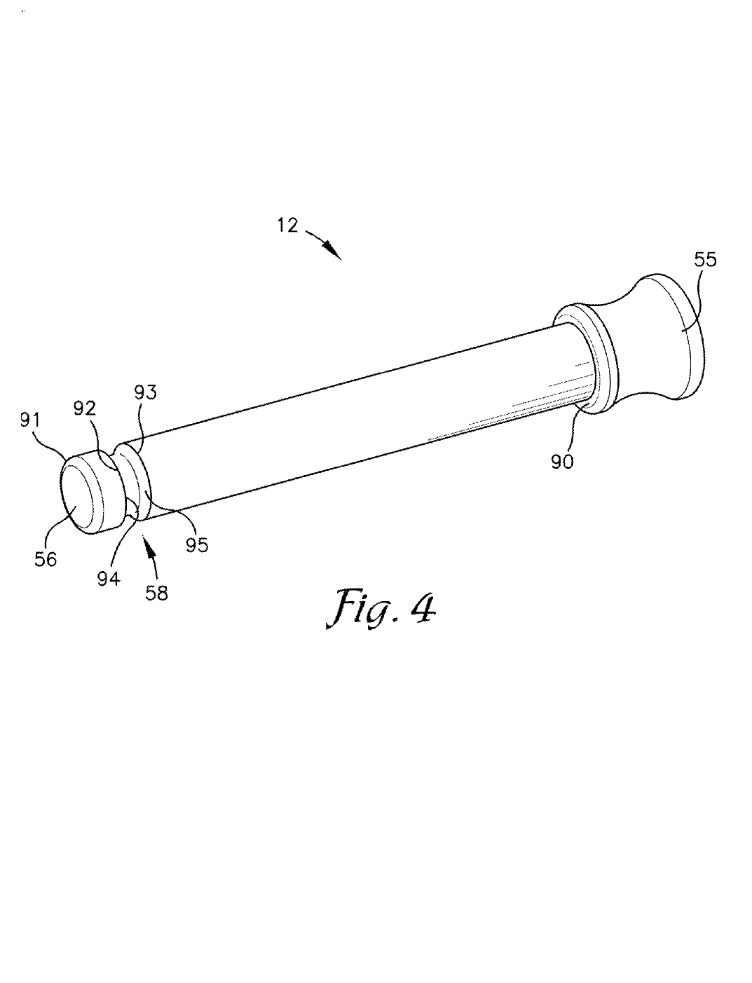

Referring now to FIG. 4, in the embodiment shown, the hitch pin 12 is generally cylindrical and is sized to fit snugly within the pin receiving openings 28a and 28b formed in the vehicle-mounted receiver tube 22 and the pin receiving opening 27 formed in the shank 26 of the hitch assembly 20. The hitch pin 12 extends longitudinally a distance corresponding to the width of the vehicle-mounted receiver tube 22, such that when the hitch pin 12 extends through the vehicle-mounted receiver tube 22 and the trailer hitch shank 26, a flange or head 90 formed on the head end 55 of the hitch pin 12 abuts against the sidewall 29a of the hitch receiver tube 22, and the distal end 56 of the hitch pin 12 and the first ball receiving groove 58 extend past the sidewall 29b of the hitch receiver tube 22 sufficiently to allow the hitch pin 12 to be lockably secured to the locking receiver 13.

The hitch pin 12 is sized to fit snugly within the sidewall 71 of the pin receptacle 62, allowing the distal end 56 of the hitch pin 12 to engage portions of the detent balls 75 which extend inward from the ball channels 74 and into the pin cavity 72 when the pin receptacle 62 is in the set position. The hitch pin 12 includes a cam edge 91, which forces the detent balls 75 outward through the ball channels 74 as the hitch pin 12 is advanced into the locking receiver 13. The cam edge 91 may be referred to as a distal cam edge 91 and, in the embodiment shown, the cam edge 91 comprises a rounded edge or fillet along which the detent balls 75 roll as the hitch pin 12 is pressed into the pin receptacle 62. It is understood, however, that the cam edge 91 may comprise one or more rounded surfaces, chamfered surfaces, beveled surfaces, and/or combinations thereof without departing from the scope of embodiments of the invention described herein.

The first detent receiving groove 58 is generally hemispherical and circumscribes a longitudinal section of the hitch pin 12, extending inward into the hitch pin 12 and forming opposingly oriented first and second edges 92 and 93 and first and second curved surfaces 94 and 95 which curve inward from the first and second edges 92 and 93, respectively, and converge at an axis of symmetry of the first detent receiving groove 58. In an embodiment, the curvatures of the first and second surfaces 94 and 95 may correspond to the curvature of the ball bearings 75, allowing portions of the ball bearings 75 to fit against the first and second surfaces 94 and 95 when the hitch pin 12 is secured to the locking receiver 13. The first edge 92 is oriented nearer to the distal end 56 of the hitch pin 12 and the second edge 93 is oriented nearer to the head end 55 of the hitch pin 12, with the first curved surface 94 situated between the distal end 56 and the second curved surface 95. The first edge 92, which may be referred to as a proximal cam edge 92, cooperates with the first curved surface 94 to force the detent balls 75 radially outward through the ball channels 74 as the hitch pin 12 is removed from the locking receiver 13. It is foreseen that the first edge 92 may be rounded, chamfered, or otherwise contoured.

The first ball receiving groove 58 is spaced longitudinally inward from the distal end 56 of the hitch pin 12 a distance corresponding to the distance between a first abutment surface 100 of the pin receptacle base 70 and a plane extending transverse to the pin receptacle 62 and bisecting the ball channels 74. When the hitch pin 12 is advanced into the pin receptacle 62 such that the distal end 56 abuts against the first abutment surface 100 (see FIGS. 14-16), the axis of symmetry of the first ball receiving groove 58 extends approximately in the transverse plane that bisects the ball channels 74, allowing the ball bearings 75 to be advanced inward through the ball channels 74 until portions of the detent balls 75 are received by the first ball receiving groove 58.

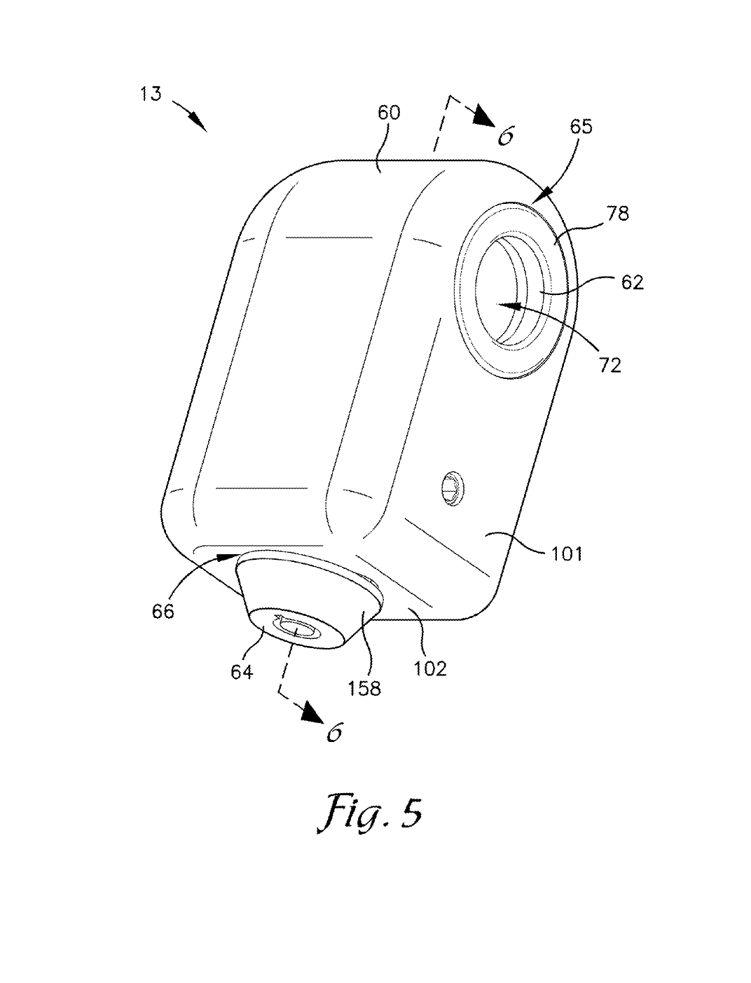

Referring now to FIGS. 5 and 6, the receptacle receiving chamber 65 and the lock receiving chamber 66 extend inward from respective side surfaces 101 and 102 of the housing block 60. The receptacle receiving chamber 65 is generally cylindrical and is sized to receive the pin receptacle 62 such that the sidewall 69 of the receptacle receiving chamber 65 and the outer surface of the sidewall 71 of the pin receptacle 62 extend in closely spaced relation to each other, allowing for sliding travel of the pin receptacle 62 within the receptacle receiving chamber 65 in a direction extending along a longitudinal axis extending centrally through the receptacle receiving chamber 65.

The second detent receiving groove 68 is generally hemispherical and circumscribes a longitudinal section of the receptacle receiving chamber 65, extending outward into the housing block 60 and forming opposingly oriented first and second edges 104 and 105 and first and second curved surfaces 106 and 107 which curve inward from the first and second edges 104 and 105, respectively, and converge at an axis of symmetry of the second detent receiving groove 68. In an embodiment, the curvatures of the first and second surfaces 106 and 107 may correspond to the curvature of the detent balls 75, allowing portions of the detent balls 75 to fit against the first and second surfaces 106 and 107 when the hitch pin 12 is advanced into the pin receptacle 62. The first edge 104 is oriented nearer to the cup chamber end wall 77 and the second edge 105 is oriented nearer to the side surface 101 of the housing block 60, with the first curved surface 106 situated between the end wall 77 and the second curved surface 107. In the embodiment shown, the first and second edges 104 and 105 are rounded edges, allowing the ball bearings 75 to roll into and out of the second detent receiving groove 68 as the hitch pin 12 is advanced into or pulled out of the pin receptacle 62. It is understood that the first and second edges 104 and 105 may comprise other contours, such as straight or chamfered, without departing from the scope of embodiments of the invention described herein.

The second ball receiving groove 68 is spaced apart from the cup chamber end wall 77 a distance corresponding to the distance between a second abutment surface 108 of the pin receptacle base 70 and a plane extending transverse to the pin receptacle 62 and bisecting the ball channels 74 of the pin receptacle 62. When the pin receptacle 62 is pressed into the receptacle receiving chamber 65 such that the second abutment surface 108 abuts against the end wall 77, the axis of symmetry of the second ball receiving groove 68 extends approximately in the transverse plane which bisects the ball channels 74. With the pin receptacle 62 so situated, and the hitch pin 12 oriented such that its distal end 56 abuts against the first abutment surface 100, the ball bearings 75 may be urged outward into the second ball receiving groove 68 or drawn inward into the first ball receiving groove 58 as the hitch pin 12 is secured to and removed from the locking receiver 13.

As best shown in FIG. 6, a first spring recess 111 extends into the housing block 60 from the cup chamber end wall 77, and a corresponding second spring recess 112 extends into the base 70 of the pin receptacle 62 from the second abutment surface 108 thereof. In the embodiment shown, the first and second spring recesses 111 and 112 extend coaxially along the central longitudinal axis of the receptacle receiving chamber 65 and are generally cylindrical such that outer portions of the biasing member 76, which is a spring 76 in the embodiment shown, extend in closely spaced relation to a sidewall 113 of the first spring recess 111 and a sidewall 114 of the second spring recess 112 as the spring 76 compresses and extends. One end of the spring 76 abuts an offset end wall 115 of the first spring recess 111 and the other end of the spring 76 abuts an offset end wall 116 of the second spring recess 112, with the end walls 115 and 116 sufficiently spaced apart from each other to allow the spring 76 to be surrounded by the first and second spring recesses 111 and 112 when the pin receptacle 62 is pressed into the receptacle receiving chamber 65.

The bolt-receiving groove 73 formed in the pin receptacle 62 circumscribes a longitudinal section of the pin receptacle base 70, extending into the base 70 to form a pair of opposing sidewalls 120a and 120b between which the bolt 79 of the lock barrel 64 extends when the pin receptacle 62 is biased to the set position and the lock barrel 64 is advanced to the locked position. In the embodiment shown, when the lock barrel 64 is advanced to the locked position, the bolt 79 extends in closely spaced relation to the sidewalls 120a and 120b of the bolt groove 73 such that the bolt 79 fixes the position of the pin receptacle 62 within the receptacle receiving chamber 65.

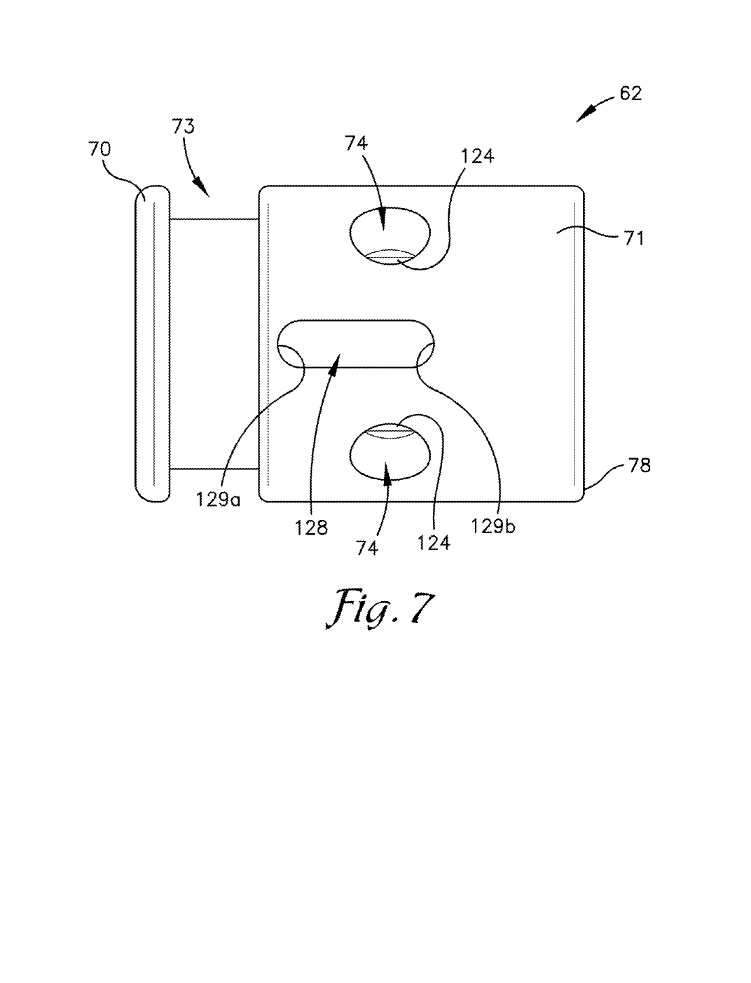

The ball channels 74 formed in the sidewall 71 of the pin receptacle 62 are longitudinally positioned to enable the detent balls 75 situated therein to be urged outward into the second ball receiving groove 68 or drawn inward into the first ball receiving groove 58. The ball channels 74are generally obround or stadium shaped in cross-section and are spaced apart at approximately equidistant intervals about the circumference of the sidewall 71, with the width of each ball channel 74 corresponding to and slightly greater than the diameter of the detent ball 75 situated therein such that the detent balls 75 roll through the ball channels 74 as the hitch pin 12 is pressed into and pulled out of the pin receptacle 62. In the embodiment shown, traversal of the detent balls 75 through the ball channels 74 and into the inner and outer ball receiving grooves 58 and 68 is restricted by ball retaining lips 124 which, as best shown in FIG. 7, extend laterally inward along the inner surface of the pin receptacle sidewall 71 to overlap portions of the ball channels 74. The ball retaining lips 124 are positioned to engage the detent balls 75 such that when the detent balls 75 are drawn radially inward through the ball channels 74 to fit against the ball retaining lips 124, portions of each detent ball extend beyond their respective ball channels 74 and into the pin cavity 72 of the pin receptacle 62 or the inner ball receiving groove 58 of the hitch pin 12.

Referring to FIGS. 6 and 7, an elongate pin receiving groove 128 is formed in pin receptacle sidewall 71 and extends from an inner end 129a to an outer end 129b. The pin receiving groove 128 is sized to receive a pin 130 which extends from a pin chamber 132 formed in the housing block 60 beneath the second ball receiving groove 68. Engagement of the pin 130 with the inner and outer ends 129a and 129b of the pin receiving groove 128 limits movement of the pin receptacle 62 along the central longitudinal axis of the receptacle receiving chamber 65 as the hitch pin 12 is secured to or removed from the locking receiver 13, with the pin 130 abutting against the inner end 129a of the pin groove 128 when the spring 76 biases the pin receptacle 62 to the set position, and the pin 130 abutting against the outer end 129b of the pin groove 128 when the pin receptacle 62 is pressed into the receptacle receiving chamber 65 such that the base 70 abuts against the end wall 77. In the embodiment shown, the pin 130 is a set screw 130 which is threaded into the chamber 132.

As best shown in FIG. 6, the locking receiver 13 includes a first or outer seal ring 140 and a second or inner seal ring 141 which mitigate ingress of debris or moisture into the receptacle receiving chamber 65 and the pin cavity 72, respectively. The first seal ring 140 is received by a first seal receiving groove 142 which is formed in the housing block 60 and circumscribes a longitudinal section of the receptacle receiving chamber 65. The seal groove 142 extends outward into the housing block 60 from the cup chamber sidewall 69, and is situated between the outer ball groove 68 and the side surface 101 of the housing block 60. The second seal ring 141 is received by a second seal receiving groove 143 which is formed in the pin receptacle sidewall 71 and circumscribes a longitudinal section of the pin cavity 72. The seal groove 143 extends outward into the sidewall 71 from the inner surface thereof, and is situated between the ball channels 74 and the rim 78 of the pin receptacle 62.

The outer seal ring 140 extends slightly inward from the first seal groove 142 into the receptacle receiving chamber 65 to fit snugly against the pin receptacle sidewall 71, and the inner seal ring 141 extends slightly inward from the second seal groove 143 into the pin cavity 72 and is configured to fit snugly against the hitch pin 12 as the hitch pin 12 is advanced into the pin receptacle 62. The outer and inner seal rings 140 and 141 are formed of a flexible elastomeric material such as nitrile, silicone, fluorocarbon, or the like, allowing the sidewall 71 and the hitch pin 12 to slide along the seal rings 140 and 141, respectively, as the hitch pin 12 is secured to and removed from the locking receiver 13.

Referring now to FIGS. 6, 8 and 9, the lock receiving chamber 66 extends inward from the side surface 102 of the housing block 60 to an end wall 150. In the embodiment shown, the lock receiving chamber 66 forms a first pair of opposing sidewalls 151a and 151b which are generally curved and a second pair of opposing sidewalls 152a and 152b which are generally flat, with a bore 153 extending inward from the side surface 102 alongside the sidewall 152b such that the bore 153 forms a curved sidewall extending away from the sidewall 152b and into the housing block 60. A longitudinal axis extending centrally through the bore 153 extends approximately coaxial with a longitudinal axis extending centrally through the pin chamber 132. The lock receiving chamber 66 is sized in correspondence with the lock barrel 64, such that when the lock barrel 64 is received by the lock receiving chamber 66 an end wall 155 of the lock barrel 64 extends in closely spaced relation to the end wall 150 of the lock receiving chamber 66, and curved sidewalls 156a and 156b and flat sidewalls 157a and 157b of the lock barrel 64 extend in closely spaced relation to the curved sidewalls 151a and 151b and the flat sidewalls 152a and 152b of the lock receiving chamber 66, respectively.

An enlarged head 158 extends outward from the lock barrel 64 and abuts against the side surface 102 of the housing block 60. In an embodiment, the enlarged head 158 extends sufficiently outward to cover the bore 153 which extends alongside the lock receiving chamber 66, and a seal (not shown) may be situated between the enlarged head 158 and the side surface 102 to mitigate ingress of debris or moisture into the lock receiving chamber 66 and the bore 153. It is foreseen that a lock cap (not shown) may be attached to the lock barrel 64 to selectively protect the lock barrel 64 from the ingress of debris or moisture, or to allow a key (not shown) to enter the lock barrel 64 and advance the lock barrel 64 between the unlocked position and the locked position. The lock cap may foreseeably be connected by a living hinge (not shown) to a mounting ring or support ring (not shown) which extends between the enlarged head 158 of the lock barrel 64 and the side surface 102 of the housing block 60.

A bolt passageway 160 extends from the lock chamber end wall 150 along a longitudinal axis extending centrally through the lock receiving chamber 66, such that the bolt passageway 160 extends between and connects the lock receiving chamber 66 and the receptacle receiving chamber 65. The bolt 79 is extendable from the lock end wall 155 to extend axially through the bolt passageway 160, with the bolt 79 extendable into the bolt groove 73 when the pin receptacle is in the set position (see FIG. 15).

It should be understood that a pin receiving feature (not shown), such as a hole or groove, is formed in the sidewall 157a of the of the lock barrel 64, with the pin receiving feature sized to receive a pin 170 extending inward from a pin chamber 172 formed in the housing block 60 (see FIG. 6). In the embodiment shown, the pin chamber 172 extends inward from the side surface 101 of the housing block 60 to the curved sidewall 154 of the bore 153. When received by the pin receiving feature, the pin 170 prevents axial and rotational movement of the lock barrel 64, thereby fixedly retaining the lock barrel 64 within the lock receiving chamber 66. In the embodiment shown, the pin 170 is a set screw 170 which is threaded into the chamber 172.

Operation of the locking hitch pin assembly 11 is now described in accordance with an embodiment of the invention. The shank 26 of the hitch assembly 20 is advanced into the vehicle-mounted hitch receiver tube 22 until the pin receiving opening 27 formed in the shank 26 is coaxially aligned with the pin receiving openings 28a and 28b formed in the sidewalls 29a and 29b of the receiver tube 22 such that the hitch pin 12 is extendable through the axially aligned pin receiving openings 27, 28a, 28b. With the pin receptacle 62 of the locking receiver 13 in the set position and the lock 64 of the locking receiver 13 in the unlocked position, the hitch pin 12 and the locking receiver 13 are separated from each other and situated proximate to the tube receiver sidewalls 29a and 29b such that the distal end 56 of the hitch pin 12 faces the tube receiver sidewall 29a and the side surface 101 of the locking receiver 13 faces the tube receiver sidewall 29b. The locking receiver 13 is positioned with the central longitudinal axis of the receptacle receiving chamber 65 extending coaxial with an axis extending through the pin receiving openings 27, 28a, 28b of the shank 26 and the tube receiver sidewalls 29a and 29b, and the hitch pin 12 is advanced through the aligned pin receiving openings 27, 28a, 28b until the distal end 56 extends beyond the tube receiver sidewall 29b and enters the pin receptacle 62 to engage the portions of the detent balls 75 which extend into the pin cavity 72, as shown in FIG. 12.

With the distal end 56 of the hitch pin 12 and the detent balls 75 so engaged, the pressing force of the hitch pin 12 is transferred through the detent balls 75 to the pin receptacle 62, overcoming the force of the spring 76 to slide the pin receptacle 62 inward within the receptacle receiving chamber 65. It should be understood that the housing block 60 is held in the position described previously, as the hitch pin 12 is pressed against the detent balls 75, 76, thereby allowing the pin receptacle 62 to move relative to the housing block 60.

As the pin receptacle 62 slides inward along the central longitudinal axis of the receptacle receiving chamber 65, the sidewall 69 of the receptacle receiving chamber 65 maintains the positions of the detent balls 75 within the ball channels 74 and keeps portions of the detent balls 75 extended into the pin cavity 72. When the pin receptacle 62 is pressed inward such that a transverse plane intersecting the ball channels 74 extends through the outer ball groove 68, the hitch pin 12 forces the detent balls 75 to roll along the cam edge 91 of the hitch pin 12 and urges the detent balls 75 through the ball channels 74 until the detent balls 75 roll along the second edge 105 of the outer ball receiving groove 68 and fit against the first and second surfaces 106 and 107 thereof.

With the detent balls 75 received by the outer ball receiving groove 68 and disengaged from the distal end 56 of the hitch pin 12, the second abutment surface 108 of the pin receptacle 62 abuts against the end wall 77 of the receptacle receiving chamber 65 and the spring 76 is surrounded by the first and second spring recesses 111 and 112. The hitch pin 12 is pressed further inward toward the base 70 of the pin receptacle 62, with the longitudinal section of the hitch pin 12 which extends between the distal end 56 and the cam edge 92 of the inner ball receiving groove 58 maintaining the positions of the detent balls 75 within the ball channels 74 to keep portions of the detent balls 75 received within the outer ball receiving groove 68. As the distal end 56 of the hitch pin 12 approaches the first abutment surface 100 of the pin receptacle 62, the cam edge 92 of the inner ball receiving groove 58 extends through a transverse plane intersecting the ball channels 74 and the detent balls 75 are forced inward, out of the outer ball receiving groove 68 and through the ball channels 74 until the detent balls 75 roll along the cam edge 92 and into the inner ball receiving groove 58, fitting against the first and second surfaces 94 and 95 thereof.

When the detent balls 75 are received within the inner ball receiving groove 58, the hitch pin 12 and the locking receiver 13 are secured to each other with the flange 90 of the hitch pin 12 abutting against the sidewall 29a of the hitch receiver tube 22 and the rim 78 of the pin receptacle 62 and the side surface 101 of the housing block 60 abutting against the sidewall 29b of the hitch receiver tube 22. External forces are removed from the hitch pin 12 and the locking receiver 13, allowing the spring 76 to force the pin receptacle 62 outward along the central longitudinal axis of the receptacle receiving chamber 65 such that the pin receptacle rim 78 abuts against the tube hitch receiver sidewall 29b and the housing block side surface 101 is spaced apart therefrom.

When the spring 76 biases the pin receptacle 62 to the set position with the inner end 129a of the pin groove 128 abutting against the set screw 130, the lock 64 is advanced from the unlocked position to the locked position such that the bolt 79 extends through the bolt passageway 160 and into the bolt groove 73 formed in the pin receptacle base 70. With the hitch pin 12 thereby lockably secured to the locking receiver 13, the locking hitch pin assembly 11 impedes removal of the hitch assembly 20 from the hitch receiver tube 22 and enables repeated use of the towing vehicle and hitch assembly 20 to pull trailers and other pieces of equipment without having to remove the hitch assembly 20 from the hitch receiver tube 22 for storage in a secondary location such as the towing vehicle cab to prevent theft of the hitch assembly 20 between uses.

When removal of the hitch assembly 20 from the hitch receiver tube 22 is desired, the lock 64 is advanced from the locked position to the unlocked position such that the bolt 79 retracts out of the bolt groove 73, through the bolt passageway 160, and into the lock barrel 64. With the locking receiver 13 unlocked, the housing block 60 is pressed inward toward the hitch receiver sidewall 29b such that the pin receptacle 62 slides inward within the receptacle receiving chamber 65 against the force of the spring 76 until the second abutment surface 108 of the pin receptacle 62 abuts against the end wall 77 of the receptacle receiving chamber 65, and the pin receptacle rim 78 and housing block side surface 101 abut against the sidewall 29b.

With the hitch pin 12 and locking receiver 13 thereby positioned as shown in FIG. 14, the hitch pin 12 is pulled outward along the central longitudinal axis of the receptacle receiving chamber 65 such that the detent balls 75 roll along the cam surface 94 and the cam edge 92 urges the detent balls 75 radially outward, out of the inner ball receiving groove 58 and through the ball channels 74 until the detent balls 75 roll along the first edge 104 of the outer ball receiving groove 68 and fit against the first and second surfaces 106 and 107 thereof. When the detent balls 75 are pushed off of the cam edge 92, the hitch pin 12 is pulled further out of the pin receptacle 62 and the longitudinal section of the hitch pin 12 which extends between the distal end 56 and the cam edge 92 maintains the positions of the detent balls 75 within the ball channels 74, keeping portions of the detent balls 75 received within the outer ball receiving groove 68. As the distal end 56 of the hitch pin 12 extends through a transverse plane intersecting the ball channels 74, the detent balls 75 are forced inward through the ball channels 75 and roll along the cam edge 91 of the hitch pin 12 until portions of the detent balls 75 extend into the pin cavity 72 as shown in FIG. 13.

With the hitch pin 12 disengaged from the detent balls 75, the spring 76 biases the pin receptacle 62 to the set position and the hitch pin 12 is pulled out of the pin receptacle 62 and through the axially aligned pin receiving openings 27, 28a, 28b of the hitch receiver tube 22 and the hitch assembly shank 26. The hitch pin 12 and the locking receiver 13 are thereby separated from each other, allowing the hitch assembly 20 to be removed from the hitch receiver tube 22. When further use of the hitch assembly 20 is desired, the shank 26 is inserted into the hitch receiver tube 22, and the hitch pin 12 and the locking receiver 13 are lockably secured to each other as described above.

It is to be understood that while certain forms of the present invention have been illustrated and described herein, the present invention is not to be limited to the specific forms or arrangement of parts described and shown. For example, the hitch pin has been described as being sized to extend through aligned mounting holes formed in a vehicle-mounted tube receiver and a shank of the hitch assembly before being lockably secured to the locking receiver. It is foreseen, however, that the hitch pin may be sized to extend through aligned mounting holes or mounting features formed in side beam elements and a drawbar or pin block element of the hitch assembly before being lockably secured to the locking receiver. Thus, the inventive locking hitch pin assembly is configured to prevent theft of the hitch assembly and elements thereof, including hitch pins, side beams, hitch ball mounts, and other elements.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure is intended to demarcate those structures as including a plurality of possible arrangements or designs within the scope of the disclosure and readily identifiable by one of skill in the art to perform the particular function in a similar way without specifically listing all such arrangements or designs. Certain features and sub-combinations are of utility and may be employed without reference to other features and sub-combinations and are contemplated within the scope of the claims.

As used in the claims, identification of an element with an indefinite article “a” or “an” or the phrase “at least one” is intended to cover any device assembly including one or more of the elements at issue. Similarly, references to first and second elements, or to a pair of elements, is not intended to limit the claims to such assemblies including only two of the elements, but rather is intended to cover two or more of the elements at issue. Only where limiting language such as “a single” or “only one” with reference to an element, is the language intended to be limited to one of the elements specified, or any other similarly limited number of elements.

What is claimed is:

1. A hitch pin assembly for preventing theft of a trailer hitch, the hitch pin assembly comprising:
a hitch pin having a first detent receiving groove formed therein, the first detent receiving groove circumscribing the hitch pin;
a housing block having a second detent receiving groove formed therein; and
a pin receptacle received within the housing block and sized to receive the hitch pin, the pin receptacle having a detent channel formed therein in which a detent extends the detent receivable by the first detent receiving groove and the second detent receiving groove, the detent channel extendable between the first detent receiving groove and the second detent receiving groove;
wherein upon advancement of the hitch pin into the pin receptacle, the hitch pin urges the detent through the detent channel.

2. The hitch pin assembly as in claim 1, further comprising a biasing member extending between the housing block and a base of the pin receptacle, the biasing member biasing the pin receptacle to a set position wherein the detent is spaced apart from the second detent receiving groove.

3. The hitch pin assembly as in claim 2, further comprising a lock received within the housing block, the lock including a bolt selectively advanceable to engage the base of the pin receptacle when the pin receptacle is in the set position.

4. The hitch pin assembly as in claim 3, further comprising the base of the pin receptacle having a bolt receiving groove formed therein, the bolt is advanceable into the bolt receiving groove.

5. The hitch pin assembly as in claim 1, wherein the pin receptacle includes a first abutment surface abuttable against a distal end of the hitch pin when the hitch pin is received within the pin receptacle.

6. The hitch pin assembly as in claim 5, wherein the first detent receiving groove is spaced away from the distal end of the hitch pin a distance corresponding to a distance between the first abutment surface and a plane extending transverse to the pin receptacle and bisecting the detent channel.

7. The hitch pin assembly as in claim 1, wherein the pin receptacle includes a second abutment surface abuttable against an end wall extending within the housing block.

8. The hitch pin assembly as in claim 7, wherein the second detent receiving groove is spaced away from the end wall a distance corresponding to a distance between the second abutment surface and a plane extending transverse to the pin receptacle and bisecting the detent channel.

9. A locking hitch pin assembly for preventing theft of a trailer hitch, the locking hitch pin assembly comprising:
a hitch pin;
a pin receptacle received within a housing and configured to receive the hitch pin, the pin receptacle having a detent channel extending therethrough, a detent situated within the detent channel; and
a lock received within the housing, the lock selectively advanceable between a locked position and an unlocked position;
wherein when pressed into the pin receptacle, the hitch pin engages the detent and forces the detent to traverse the detent channel; and
the hitch pin, the pin receptacle, and the housing cooperate to urge the detent outward to an outer detent receiving groove circumscribing the pin receptacle and draw the detent inward to an inner detent receiving groove circumscribing the hitch pin.

10. The locking hitch pin assembly as in claim 9, wherein the pin receptacle extends within a receptacle receiving chamber and the lock extends within a lock receiving chamber, the receptacle receiving chamber and the lock receiving chamber extending in generally transverse relation to each other.

11. The locking hitch pin assembly as in claim 10, wherein the lock receiving chamber is connected to the receptacle receiving chamber by a bolt passageway.

12. The locking hitch pin assembly as in claim 11, further comprising the pin receptacle having a bolt receiving groove formed therein, advancement of the lock from the unlocked position to the locked position extending a bolt through the bolt passageway and into the bolt receiving groove.

13. The locking hitch pin assembly as in claim 9, wherein a spring biases the pin receptacle to a set position, the spring extending between the pin receptacle and the housing.

14. The locking hitch pin assembly as in claim 13, wherein the lock is advanceable to the locked position when the pin receptacle is biased to the set position.

15. The locking hitch pin assembly as in claim 9, wherein the pin receptacle includes a lip extending to overlap a portion of the detent channel.

16. The locking hitch pin assembly as in claim 9, wherein the hitch pin includes a distal cam edge and a proximal cam edge, the distal cam edge urging the detent outward through the detent channel when the hitch pin is pressed into the pin receptacle, the proximal cam edge urging the detent outward through the detent channel when the hitch pin is pulled out of the pin receptacle.

17. A hitch pin assembly, the hitch pin assembly comprising:
a hitch pin having a first detent receiving feature formed therein proximate a distal end thereof;
a hitch pin receiver having a receptacle receiving chamber formed therein, the receptacle receiving chamber extending into the hitch pin receiver from a first side thereof and at least partially surrounded by a receptacle receiving chamber sidewall;
a second detent receiving feature formed in the receptacle receiving chamber sidewall and extending radially outward from the receptacle receiving chamber;
a pin receptacle slidably positioned within the receptacle receiving chamber and advanceable between a retracted position and an extended position;
a spring engaging the pin receptacle and normally biasing the pin receptacle to the extended position;
the pin receptacle having a pin receiving cavity formed therein, the pin receiving cavity sized to receive the distal end of the hitch pin and surrounded by a pin receptacle sidewall having a detent channel extending therethrough, the detent channel extending in radial alignment with the second detent receiving feature in the receptacle receiving chamber sidewall when the pin receptacle is advanced, against a biasing force of the spring, to the retracted position;
a detent positioned within the detent channel in the pin receptacle sidewall, the detent having a thickness greater than the thickness of the pin receptacle sidewall;
the first detent receiving feature in the hitch pin having a depth, which in combination with the thickness of the pin receptacle sidewall, is greater than the thickness of the detent; and
the second detent receiving feature having a depth, which in combination with the thickness of the pin receptacle sidewall, is greater than the thickness of the detent.

18. The hitch pin assembly as in claim 17, wherein the pin receptacle has a bolt receiving feature formed therein extending into the pin receptacle from an outer periphery thereof and the hitch pin assembly further includes a lock secured within a lock receiving chamber in the hitch pin receiver, the lock having a bolt advanceable between an unlocked and a locked position, wherein in the locked position the bolt is extendable from the lock and through a bolt passageway in the hitch pin receiver, the bolt passageway opening into the receptacle receiving chamber and positioned relative thereto such that when the pin receptacle is in the extended position, the bolt receiving feature formed in the pin receptacle is aligned with the bolt passageway and advancement of the bolt to the locked position advances a distal end of the bolt into the bolt receiving feature.

19. The hitch pin assembly as in claim 17, wherein the first detent receiving feature is spaced away from the distal end of the hitch pin a distance corresponding to a distance between a first abutment surface at an inner end of the pin receiving cavity of the pin receptacle and a plane extending transverse to the pin receptacle and bisecting the detent channel.

20. The hitch pin assembly as in claim 19 wherein, upon advancement of the distal end of the hitch pin into the pin receiving cavity of the pin receptacle in the extended position through an application of an inwardly directed force on the hitch pin, the distal end of the hitch pin engages the detent preventing further advancement of the hitch pin into the pin receiving cavity of the pin receptacle until the pin receptacle is advanced to the retracted position whereupon the application of the inwardly directed force on the hitch pin forces the detent radially outward through the detent channel in the pin receptacle sidewall and into the second detent receiving feature in the receptacle receiving chamber sidewall such that the distal end of the hitch pin is advanced by the inwardly directed force past the detent and into engagement with the first abutment surface at the inner end of the pin receiving cavity and the first detent receiving feature is aligned with the detent channel in the pin receptacle and the second detent receiving feature in the receptacle receiving chamber sidewall, and thereafter, upon release of the inwardly directed force, the spring biases the pin receptacle outward such that outward advancement of the pin receptacle relative to the receptacle receiving chamber sidewall forces the detent out of the second detent receiving feature, through the detent channel in the pin receptacle sidewall and into the first detent receiving feature in the hitch pin such that the pin receptacle and the hitch pin secured thereto by the detent advance together to the extended position.
